(19) United States
(12) Patent Application Publication
(10) Pub. No.: US 2010/0277519 A1
(43) Pub. Date: Nov. 4, 2010

(54) Liquid crystal display capable of automatically adjusting gamma value and brightness

(75) Inventor: Ki-Chan Lee, Cheonan-si (KR)

Correspondence Address: Innovation Counsel LLP, 21771 Stevens Creek Blvd, Ste. 200A, Cupertino, CA, 95014, US

(73) Assignee: Samsung Electronics Co., Ltd.

(21) Appl. No.: 11/545,964

(22) Filed: Oct. 10, 2006

(30) Foreign Application Priority Data
Oct. 13, 2005 (KR) 2005-96632

(51) Int. Cl. G09G 3/36; G09G 5/10

(52) U.S. Cl. 345/691; 345/690; 345/101

(57) ABSTRACT

A liquid crystal display that is capable of maintaining a consistent display quality regardless of variations in the liquid crystal panel temperature is presented. The liquid crystal display includes a liquid crystal panel that displays an image and a driving circuit that drives the liquid crystal display panel. The liquid crystal display panel has a temperature sensor that senses temperature variation in the liquid crystal panel and outputs a sensing signal. The driving circuit adjusts a gamma value in response to the sensing signal and drives the liquid crystal panel based on the adjusted gamma value. The gamma value is adjusted by measuring a shift in the gamma value and applying a compensation factor that is opposite in polarity but similar in magnitude to the shift.

### CROSS-REFERENCE TO RELATED APPLICATION

This application relies for priority upon Korean Patent Application No. 10-2005-0096632 filed on Oct. 13, 2005, the content of which is herein incorporated by reference in its entirety.

### BACKGROUND OF THE INVENTION

1. Field of the Invention

The present invention relates to a display apparatus. More particularly, the present invention relates to a liquid crystal display capable of automatically compensating gamma and brightness.

2. Description of the Related Art

Recently, liquid crystal display is widely employed as a large outdoor/indoor display. The possibility of outdoor usage means that the liquid crystal display is capable of operating normally not only under room temperature conditions but in conditions where the temperature is below minus 40° Celsius or over 40° Celsius. Liquid crystals that are employed in a liquid crystal display have a viscosity that varies with ambient temperature, making the response speed of the liquid crystal vary. Further, when the ambient temperature changes, the liquid crystal display has an effect on the operational characteristics of device circuits. As a result of this effect, gamma and brightness properties of the liquid crystal display are distorted.

FIG. 1 is a graph showing the brightness of a conventional liquid crystal display as a function of gray scales according to temperature. FIG. 2 is a graph showing a gamma property of a conventional liquid crystal display according to temperature. The brightness and gamma property shown in FIGS. 1 and 2 have been measured by changing the heating temperature in a constant temperature chamber in which a patterned-vertically alignment type liquid crystal display is placed.

As shown in FIGS. 1 and 2, the brightness and gamma property of the liquid crystal display vary with heating temperature. As shown in FIG. 1, the maximum brightness of the liquid crystal display decreases as the heating temperature increases when the gray scale level is below about 180. However, the maximum brightness increases as the heating temperature increases when the gray scale level is above about 180. FIG. 2 shows that the temperature dependence of gamma property is different from the temperature dependence pattern of brightness. For example, as shown, the gamma value of the liquid crystal display linearly increases with an increase in heating temperature. The brightness and gamma values of the liquid crystal display have effects on the image display quality of the liquid crystal display. Thus, variations in the brightness and gamma values due to a change in the heating temperature adversely affect the image display quality of the liquid crystal display. A method of providing a constant image display quality in spite of the changes in heating temperature would be desirable.

### SUMMARY OF THE INVENTION

The present invention provides a liquid crystal display capable of automatically adjusting the gamma value and brightness to maintain a consistent display quality.

In one aspect, the present invention is a liquid crystal display that includes a liquid crystal panel having a plurality of pixels, a temperature sensor, and a driver. The temperature sensor, which is provided inside the liquid crystal panel, is capable of sensing a temperature variation in the liquid crystal panel and outputting a sensing signal. The driver adjusts a gamma value in response to the sensing signal and drives the liquid crystal panel based on the adjusted gamma value.

In another aspect, the present invention is a liquid crystal display that includes a liquid crystal panel having a plurality of pixels, a temperature sensor, a sensor controller, a gamma compensator and a driving circuit. The temperature sensor, which is provided inside the liquid crystal panel, is capable of sensing a temperature variation of the liquid crystal panel and outputting a sensing signal. The sensor controller generates a temperature compensation signal having an opposite polarity to a polarity of the sensing signal in response to the sensing signal. The gamma-compensator adjusts a gamma value according to the temperature variation in response to one of the sensing signal and the temperature compensation signal. The driving circuit drives the liquid crystal panel based on the adjusted gamma.

### BRIEF DESCRIPTION OF THE DRAWINGS

The above and other advantages of the present invention will become readily apparent by reference to the following detailed description when considered in conjunction with the accompanying drawings wherein:

FIG. 1 is a graph showing the brightness of a conventional liquid crystal display at different temperatures;

FIG. 2 is a graph showing the gamma value of a conventional liquid crystal display at different temperatures;

FIG. 3 is a block diagram showing a liquid crystal display according to an exemplary embodiment of the present invention;

FIG. 4 is a block diagram showing a liquid crystal display according to another exemplary embodiment of the present invention;

FIG. 5 is a block diagram showing a liquid crystal display according to another exemplary embodiment of the present invention;

FIG. 6 is a plan view showing a liquid crystal display module configuration of the liquid crystal display shown in FIG. 3;

FIG. 7 is a cross-sectional view taken along the line I-I′ of FIG. 6;

FIG. 8 is a plan view showing another liquid crystal display module configuration of the liquid crystal display shown in FIG. 3;

FIG. 9 is a cross-sectional view showing taken along the line II-II′ of FIG. 8;

FIG. 10 is a plan view showing the temperature sensor applied to the liquid crystal display shown in FIGS. 3, 4 and 5; and

FIG. 11 is a block diagram showing the sensor controller applied to the liquid crystal display shown in FIGS. 3, 4 and 5.

### DESCRIPTION OF THE EMBODIMENTS

It will be understood that when an element or layer is referred to as being “on”, “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

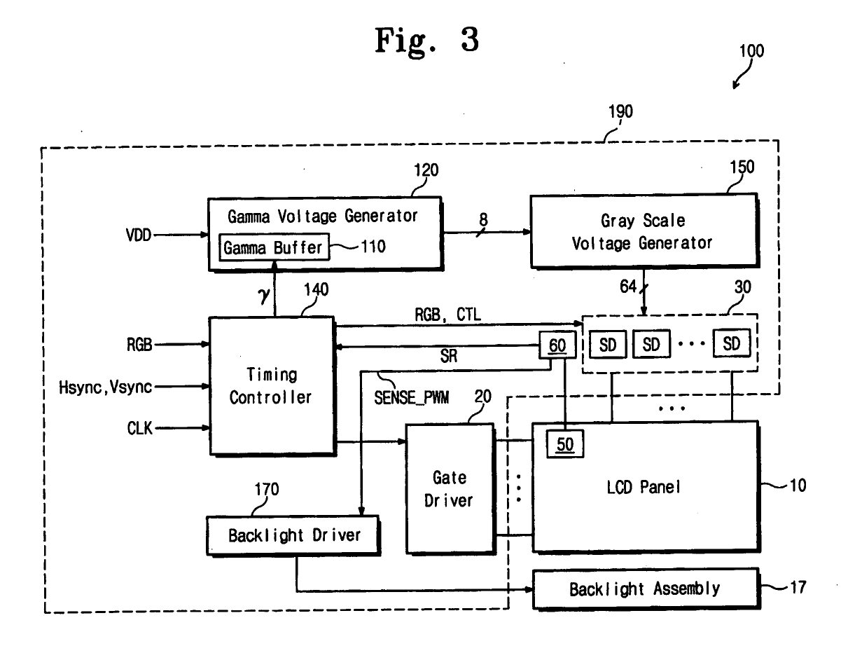

FIG. 3 is a block diagram showing a liquid crystal display according to an exemplary embodiment of the present invention.

Referring to FIG. 3, a liquid crystal display 100 includes a liquid crystal display panel 10 that displays an image and a driving circuit 190 that drives the liquid crystal display panel 10. The liquid crystal display panel 10 includes a temperature sensor 50 that can sense a temperature variation in the liquid crystal display panel 10.

The liquid crystal display panel 10 includes first and second transparent substrates, one or both of which may contain glass, and liquid crystal molecules injected between the first and second transparent substrates. Gate lines are formed on the first transparent substrate such that the gate lines are spaced apart from each other by a predetermined distance. Data lines are formed on the first transparent substrate such that the data lines are also spaced apart from each other by a predetermined distance. The gate lines and the data lines extend substantially perpendicularly to each other, and the data lines are electrically insulated from the gate lines. Thin film transistors are arranged in pixel regions defined by the gate lines and the date lines in a matrix configuration. Also, pixels are formed in the pixel regions. Each pixel has a thin film transistor, and each thin film transistor is in one of the pixels.

The first transparent substrate includes a temperature sensor 50 formed thereon to sense the inner temperature of the liquid crystal display panel 10. The temperature sensor 50 is a metal thin layer type temperature sensor. The temperature sensor 50 is formed with the thin film transistors and on the same layer as the thin film transistors without an additional process. The temperature sensor 50 is capable of accurately sensing the inner temperature of the liquid crystal display panel 10 since the temperature sensor 50 is formed inside the liquid crystal display panel 10. Thus, with the temperature sensor 50, the liquid crystal display 100 may efficiently sense the inner temperature of the liquid crystal display panel 10 without significantly increasing the manufacturing cost. The sensed inner temperature of the liquid crystal display panel 10 is used for adjustment of gamma value and brightness of the liquid crystal display 100.

The second transparent substrate includes red, green and blue (RGB) color filters formed thereon.

The liquid crystal display 10 includes a backlight assembly 17 to supply light to the liquid crystal display panel 10. The liquid crystal display 100 uses the backlight assembly 17 since the liquid crystal display panel 10 is not self-emissive. The backlight assembly 17 includes a plurality of light sources to uniformly supply light to the liquid crystal display panel 10. In a small to medium sized liquid crystal display, a white light emitting diode is used as the light source in the backlight assembly 17. In a large liquid crystal display, a cold cathode fluorescent lamp is used as the light source of the backlight assembly 17.

The driving circuit 190 includes control circuits, such as a gate driver 20, a source driver 30, a sensor controller 60, a gamma voltage generator 120, a timing controller 140, a gray scale voltage generator 150 and a backlight driver 170, to drive the liquid crystal display panel 10.

The driving circuit 190 may be formed as a tape carrier package (TCP) or a chip on glass (COG). The TCP is formed by a tape automated bonding (TAB) method that couples an integrated circuit (IC) chip to a tape film and seals the IC chip with the tape film. The COG is formed by a method of adhering a bare die to a glass substrate, so that the driving circuit 190 may be mounted on a substrate for the liquid crystal display panel 10.

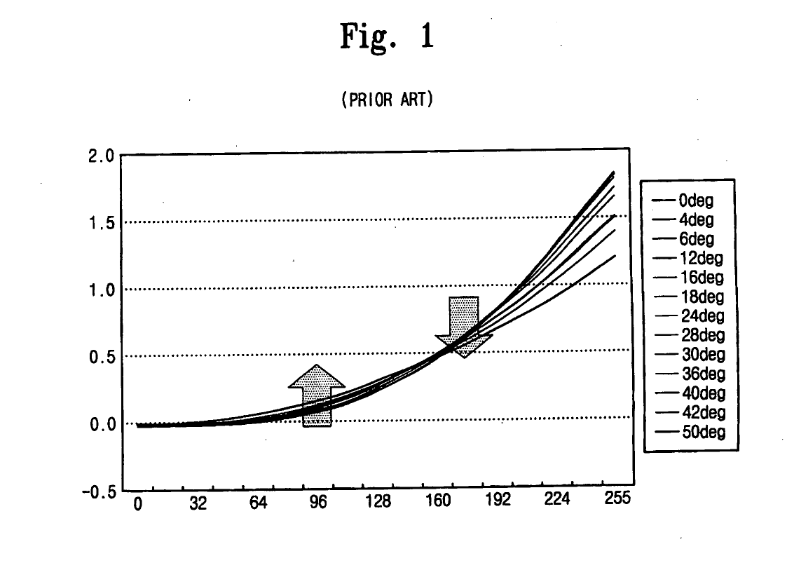

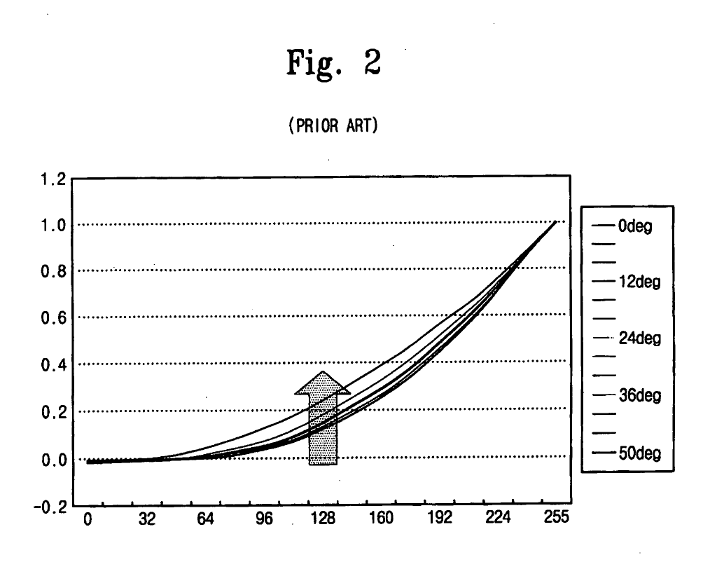

The general gamma and brightness variations with temperature are shown in FIGS. 1 and 2. And as mentioned above, a display quality of an image displayed on the liquid crystal display 100 depends on the variation of the temperature. In order to provide a consistent image quality in spite of the variation in the gamma and brightness properties in accordance with temperature, the present invention is employed. A liquid crystal display 100 of the exemplary embodiment adjusts the gamma and brightness based on the temperature variation sensed by the temperature sensor 50.

The sensor controller 60 drives and controls the temperature sensor 50. The sensor controller 60 may be formed on the same substrate as that of the source driver 30 or the timing controller 140. In the exemplary embodiment, the sensor controller 60 is formed on the substrate on which the source driver 30 is formed.

The sensor controller 60 controls an operation of the temperature sensor 50 and amplifies a temperature sensed signal SR that represents an inner temperature of the liquid crystal display panel 10 from the temperature sensor 50 to apply the temperature sensed signal SR to the timing controller 140. The sensor controller 60 generates a temperature compensation signal SENSE_COMP in response to the temperature sensed signal SR. The temperature compensation signal SENSE_COMP has a polarity opposite to a polarity of the temperature sensed signal SR. That is, when the temperature sensed signal SR has a positive temperature increment, the temperature compensation signal SENSE_COMP has a negative temperature increment of the same magnitude as the positive temperature increment of the temperature sensed signal SR. Similarly, when the temperature sensed signal SR has a negative temperature increment, the temperature compensation signal SENSE_COMP has a positive temperature increment of the same magnitude as the negative temperature increment of the temperature sensed signal SR. Thus, the effect of the temperature compensation signal SENSE_COMP is a lowering of the positive temperature increment or a raising of the negative temperature increment in the temperature variation. The sensor controller 60 pulse-width modulates the temperature sensed signal SR or the temperature compensation signal SENSE_COMP to generate a pulse width modulation signal SENSE_PWM. The pulse width modulation signal SENSE_PWM from the sensor controller 60 is applied to the backlight driver 170 to adjust the brightness level of the liquid crystal display panel 10.

The timing controller 140 generates control signals CTL and color signals RGB in response to color signals RGB, vertical and horizontal synchronization signals Vsync and Hsync, and a clock signal CLK received from a component external to the driving circuit 190. In response to the temperature sensed signal SR, the timing controller 140 decides a gamma value γ. The timing controller 140 includes a lookup table into which the gamma values γ corresponding to particular temperature values are stored. The gamma values γ determined by the timing controller 140 are stored in a gamma buffer 110 of the gamma voltage generator 120. The sensor controller 60, the timing controller 140 and the gamma voltage generator 120 interface the temperature sensed signal SR and/or the gamma value γ through a digital interfacing method such as an IIC-bus interface therebetween. The IIC-bus interface may have a simplified wiring since the IIC-bus interface uses two wires.

The gamma voltage generator 120 generates a gamma voltage corresponding to the gamma value γ stored into the gamma buffer 110. The gamma voltage generated by the gamma voltage generator 120 has a voltage level reflecting the temperature variation of the liquid crystal display panel 10. The gray scale voltage generator 150 voltage-divides the gamma voltage, (e.g., 8 gray scales) generated by the gamma voltage generator 150 and generates gray scale voltages, (e.g., 64 gray scales).

The gate driver 20 includes a plurality of gate driver parts. Each of the gate driver parts sequentially scans the gate lines to which the pixels of the liquid crystal display panel 10 are electrically connected in response to a gate driving signal. The gate driving signal is part of the control signals CTL generated by the timing controller 140. The source driver 30 also includes a plurality of source drivers SD. In response to the gray scale voltage from the gray scale voltage generator 150, each of the source drivers SD generates a data driving voltage corresponding to the color signals RGB from the timing controller 140. The data driving voltage is applied to the pixels through the data lines when the gate driver 20 scans the gate lines.

The gamma value γ is closely related to contrast and brightness of the image displayed on the liquid crystal display panel 10. More specifically, the gamma value γ indicates the slope of a line indicating a data input value against a data output value, or where the data output value is represented as “data input value ^{1/γ}”. For example, when the gamma value is 1.0, the data input value and the data output value are unchanged (null variation). When the gamma value γ is larger than 0.0 and smaller than 1.0, the image displayed on the liquid crystal display panel 10 is defocused. The image displayed on the liquid crystal display panel 10 is brightened when the gamma value γ is larger than 1.0.

The temperature sensed signal SR or the temperature compensation signal SENSE_COMP generated by the sensor controller 60 is applied to the backlight driver 170 after the temperature sensed signal SR or the temperature compensation signal SENSE_COMP is pulse-width modulated by the sensor controller 60. In the exemplary embodiment described herein, the sensor controller 60 pulse-width modulates the temperature compensation signal SENSE_COMP. In this case, the backlight driver 170 does not need to perform an additional calculation to the temperature sensed signal SR since the temperature compensation signal SENSE_COMP has an opposite polarity to that of the temperature sensed signal SR.

The pulse width modulation signal SENSE_PWM that is pulse-width modulated by the sensor controller 60 is applied to the backlight driver 170. The backlight driver 170 adjusts a tube current applied to the lamps of the backlight assembly 17 in response to the pulse width modulation signal SENSE_PWM from the sensor controller 60. When the amount of the tube current increases, the brightness of the liquid crystal display panel 10 also increases. Conversely, the brightness of the liquid crystal display panel 10 decreases when the amount of the tube current decreases. When the amount of the tube current is adjusted according to the inner temperature of the liquid crystal display panel 10, the brightness of the liquid crystal display panel 10 may be maintained at a substantially constant level.

The adjustment of the gamma value and brightness may be applied to various displays such as a plasma display panel, an electroluminescent display, a light emitting diode display, a vacuum fluorescent display, etc.

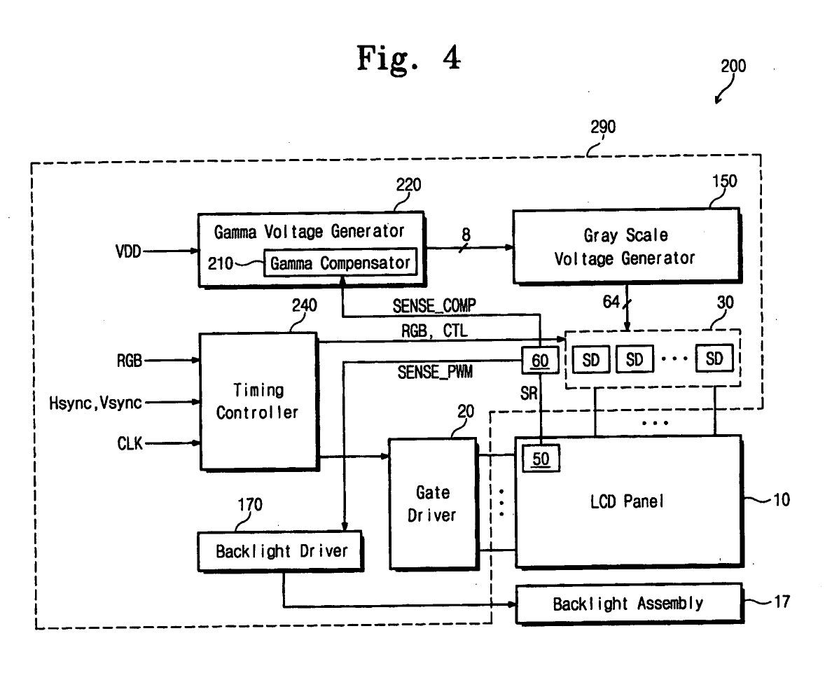

FIG. 4 is a block diagram showing a liquid crystal display according to another exemplary embodiment of the present invention. In FIG. 4, the same reference numerals denote the same elements in FIG. 3, and thus any redundant descriptions of the same elements will be omitted.

Referring to FIG. 4, a sensor controller 60 generates a temperature compensation signal SENSE_COMP in response to a temperature sensed signal SR received from a temperature sensor 50 in a liquid crystal display panel 10 and applies the temperature compensation signal SENSE_COMP to a gamma compensator 210 in a gamma voltage generator 220. The temperature compensation signal SENSE_COMP applied to the gamma compensator 210 has an analog form, and thus the analog interface between the sensor controller 60 and the gamma compensator 210 is an analog interface. The gamma compensator 210 adjusts the gamma value according to the variation in the gamma value that is caused by the temperature variation, in response to the temperature compensation signal SENSE_COMP. The gamma voltage generator 220 generates a gamma voltage corresponding to the adjusted gamma value generated by the gamma compensator 210. In the present embodiment, the gamma value used for the gamma voltage generator 220 is a predetermined gamma value that is adjusted by the gamma compensator 210. Thus, the gamma voltage generated from the gamma voltage generator 220 represents a gamma value that compensates for the temperature variation of the liquid crystal display panel 10 to provide a substantially consistent display quality.

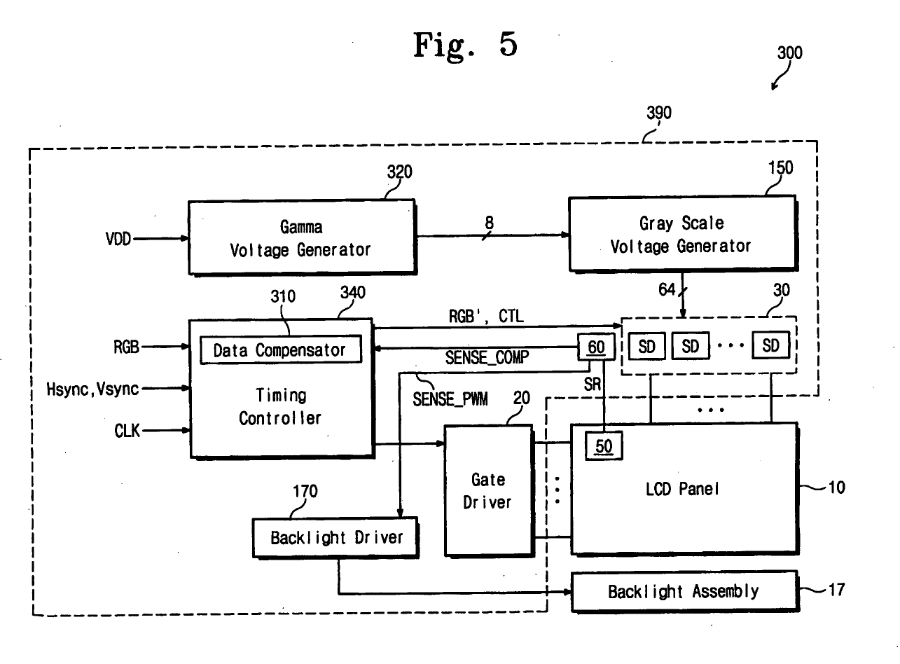

FIG. 5 is a block diagram showing a liquid crystal display according to another exemplary embodiment of the present invention. In FIG. 4, the same reference numerals denote the same elements in FIG. 3, and thus any redundant descriptions of the same elements will be omitted.

Referring to FIG. 5, the sensor controller 60 generates a temperature compensation signal SENSE_COMP in response to the temperature sensed signal SR generated by the temperature sensor 50 in a liquid crystal display panel 10 and applies the temperature compensation signal SENSE_COMP to a timing controller 340. The temperature compensation signal SENSE_COMP applied to the timing controller 340 has a digital form, and thus the interface between the sensor controller 60 and the timing controller 340 is a digital interface. In the present embodiment, the digital interface between the sensor controller 60 and the timing controller 340 may be an IIC-bus interface.

The timing controller 340 includes a data compensator 310 therein. The data compensator 310 adjusts for a variation of a color signal RGB in response to the temperature compensation signal SENSE_COMP. That is, the data compensator 310 compensates for the variation of the color signal RGB caused by the variation in the gamma value and applies the compensating color signal RGB to the source driver 30. Basically, the timing controller 340 is programmed with various methods of calculation that allows the timing controller 340 to adjust the RGB value according to the variation of the color signal RGB caused by the temperature variation. The adjusted signal is applied to the LCD panel 10 instead of the temperature compensation signal SENSE_COMP.

A gamma voltage generator 320 has a circuit configuration that is simplified to generate a basic gamma voltage. The gamma voltage generator 320 generates a gamma voltage using an initially predetermined gamma value, which may be adjusted through a user interface.

The gray scale voltage generator 150 receives the gamma voltage from the gamma voltage generator 320 to generate a gray scale voltage. The gray scale voltage generated by the gray scale voltage generator 150 is used as a reference voltage applied to display color signals RGB′ outputted from the timing controller 340.

The source driver 30 includes a plurality of source drivers SD. In response to the gray scale voltage from the gray scale voltage generator 150, each of the source drivers SD generates a data driving voltage corresponding to the color signals RGB′ from the timing controller 340. The data driving voltage is applied to the pixels through the data lines when the gate driver 20 scans the gate lines of the liquid crystal display panel 10. The data driving voltage generated by the source driver 30 represents a gamma value that is adjusted to compensate for any temperature variation in the liquid crystal display panel 10, thereby maintaining a consistent display quality.

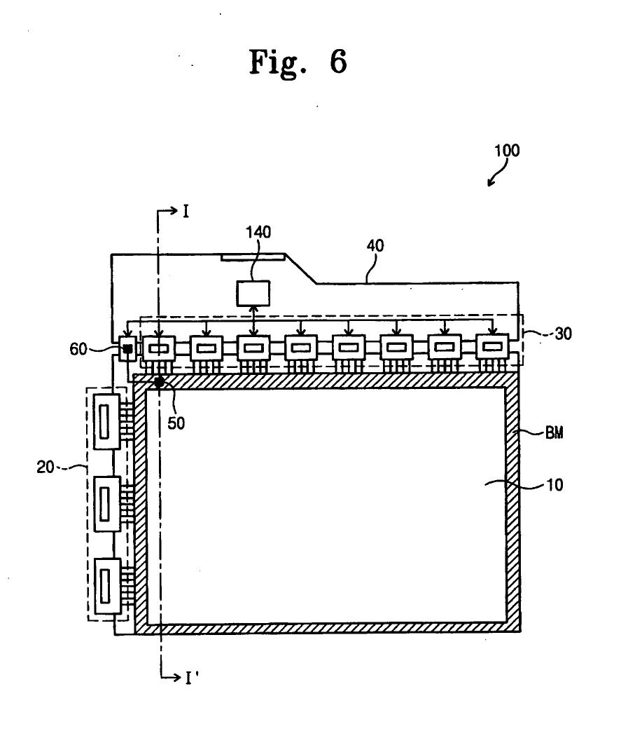

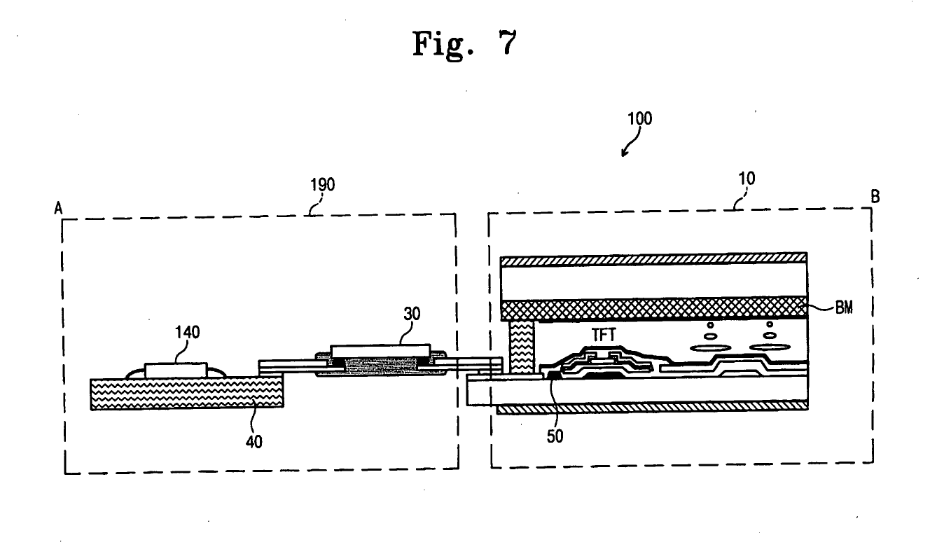

FIG. 6 is a plan view showing a liquid crystal display module configuration of the liquid crystal display shown in FIG. 3. FIG. 7 is a cross-sectional view taken along the line I-I′ of FIG. 6. FIG. 7 shows a liquid crystal display module 100 to which a chip-on-film method is applied.

Referring to FIGS. 6 and 7, the source driver 30 and the sensor controller 60 are mounted on a separate board such as a flexible film by a chip-on-film method. The driving circuit 190, except the source driver 30 and the sensor controller 60, is mounted on a printed circuit board 40. The source driver 30 and the sensor controller 60 are mounted on a separate board, typically a tape carrier package, and the source driver 30 and the sensor controller 60 are electrically connected between the printed circuit board 40 and the liquid crystal display panel 10 through wires formed on the separate board.

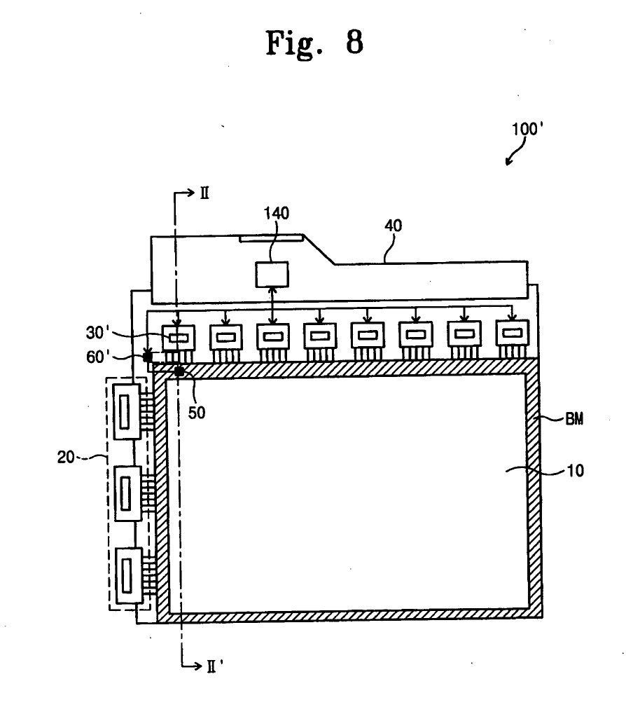

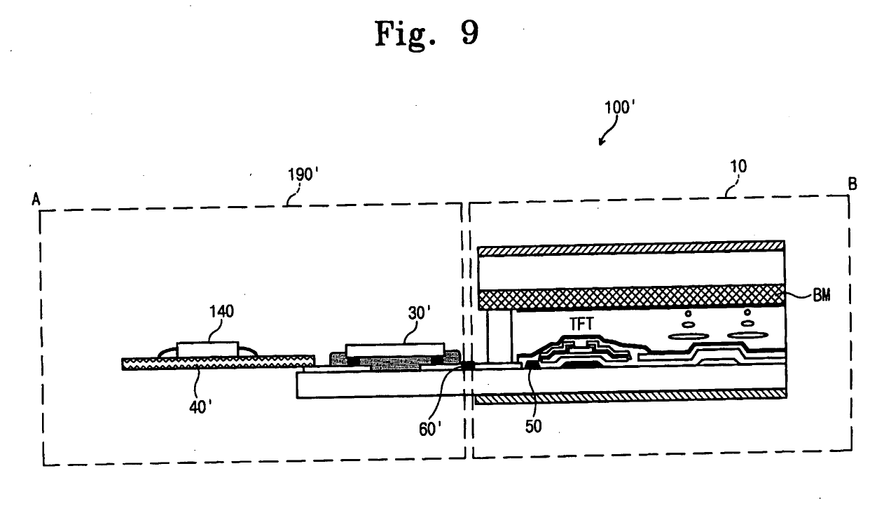

FIG. 8 is a plan view showing another liquid crystal display module configuration of the liquid crystal display shown in FIG. 3. FIG. 9 is a cross-sectional view showing taken along the line II-II′ of FIG. 8. FIG. 8 shows a liquid crystal display module 100′ to which a chip-on-glass method is applied.

Referring to FIGS. 8 and 9, the source driver 30′ and the sensor controller 60′ are mounted on the liquid crystal display panel 10 by a chip-on-glass method, and the driving circuit 190′, except the source driver 30′ and the sensor controller 60′, is mounted on a printed circuit board 40′. With the chip-on-glass method, the thickness of the liquid crystal display panel 10 may be reduced since the source driver 30′ and the sensor controller 60′ are mounted on the liquid crystal display panel 10.

As shown in FIGS. 6 to 9, each of the liquid crystal displays 100 and 100′ includes the temperature sensor 50. The temperature sensor 50 is disposed under a black matrix BM used as a light blocking layer of the liquid crystal display panel 10. In the embodiments shown, the temperature sensor 50 may be formed on a same layer as the gate electrode of the thin film transistor using same material, such as an alloy of molybdenum (Mo) and aluminum (Al). Since the temperature sensor 50 is formed in the liquid crystal display panel 10, the temperature sensor 50 may accurately sense the inner temperature of the liquid crystal display panel 10 without being affected by external factors. Also, since the temperature sensor 50 may be formed with the gate electrode of the thin film transistor, no extra stage is needed in the manufacturing process for the liquid crystal display panel 10. Further, an entire area of the liquid crystal display may be reduced since the temperature sensor 50 is formed under the black matrix BM.

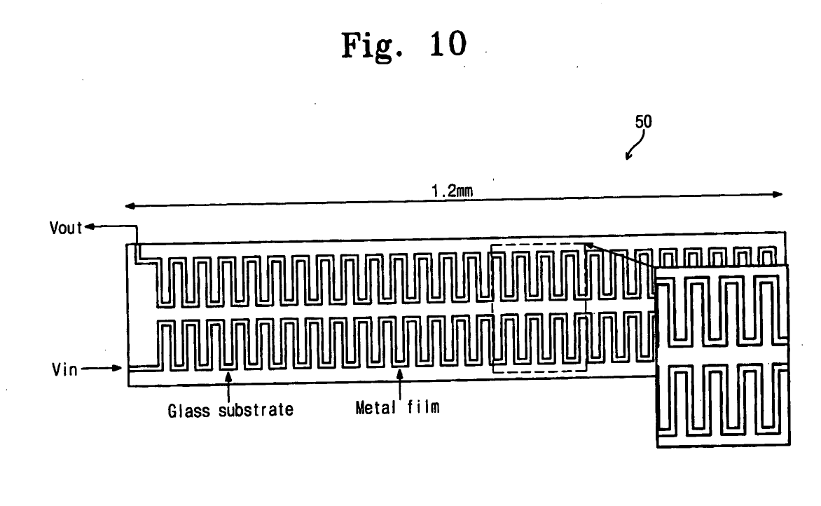

FIG. 10 is a plan view showing the temperature sensor applied to the liquid crystal display shown in FIGS. 3, 4 and 5.

Referring to FIG. 10, the temperature sensor 50 is a resistor including the AlMo alloy. In order to form the temperature sensor 50, a metal thin layer having the AlMo alloy is formed in a square wave shape. The temperature sensor 50 receives an input alternating current voltage Vin through an input terminal and outputs the input alternating current voltage Vin as an output alternating current voltage Vout through an output terminal. The input alternating current voltage Vin is applied to the temperature sensor 50 from the sensor controller 60. When the inner temperature of the liquid crystal display panel 10 changes, the resistance of the temperature sensor 50 also changes since the temperature sensor 50 includes the metal thin layer. The sensor controller 60 senses this change in the resistance of the temperature sensor 50 based on a change of the input alternating current voltage Vin received by the input terminal and the output alternating current voltage Vout outputted from the output terminal, thereby obtaining the amount of temperature shift.

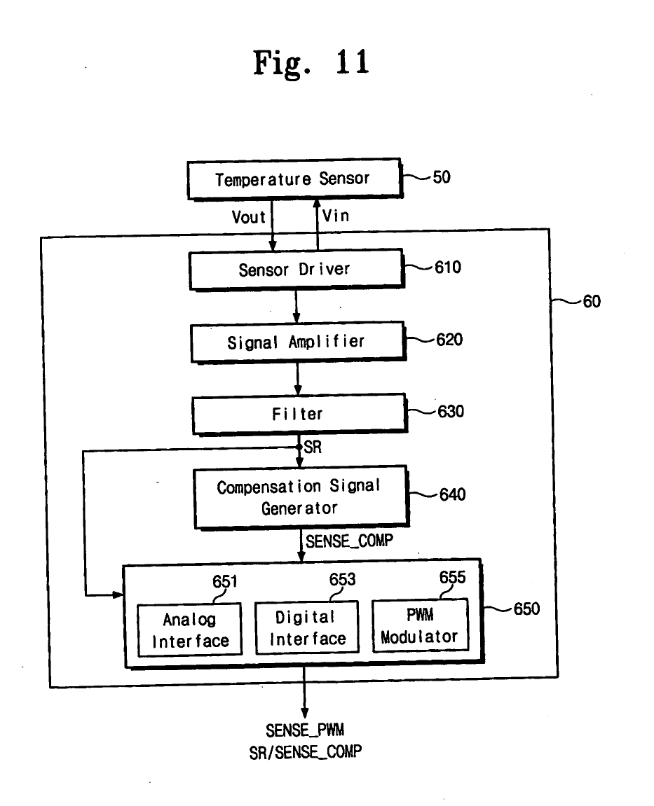

FIG. 11 is a block diagram showing the sensor controller applied to the liquid crystal display shown in FIGS. 3, 4 and 5.

Referring to FIG. 11, the sensor controller 60 includes a sensor driver 610, a signal amplifier 620, a filter 630, a compensation signal generator 640 and an interface part 650.

The sensor driver 610 applies the input alternating current voltage Vin at a predetermined voltage level to the temperature sensor 50 and receives the output alternating current voltage Vout from the temperature sensor 50. The signal amplifier 620 amplifies the output alternating current voltage Vout that is originally from the temperature sensor 50. The filter 630 removes a noise component from the amplified output alternating current voltage Vout before outputting the amplified output alternating current voltage Vout as the temperature sensed signal SR. In the present embodiment, the filter 630 may be any of various filters such as a low pass filter, a median filter, etc.

The compensation signal generator 640 compares the temperature sensed signal SR applied from the filter 630 with a predetermined reference voltage signal. Based on the comparison, the compensation signal generator 640 analyzes the variation of the output alternating current voltage Vout from the temperature sensor 50 to generate the temperature compensation signal SENSE_COMP having the opposite polarity to that of the temperature sensed signal SR. That is, when the temperature sensed signal SR has a positive temperature increment, the temperature compensation signal SENSE_COMP has a negative temperature increment corresponding to the positive temperature increment of the temperature sensed signal SR, and vice versa. Thus, the temperature compensation signal SENSE_COMP may be used to compensate for the upward or downward shift in the gamma and brightness values of the liquid crystal display panel 10.

The temperature sensed signal SR from the filter 630 and the temperature compensation signal SENSE_COMP from the compensation signal generator 640 are applied to the interface part 650. The interface part 650 includes an analog interface 651, a digital interface 653 and a pulse width modulation (PWM) modulator 655. The analog interface 651 outputs the temperature sensed signal SR and the temperature compensation signal SENSE_COMP in an analog form, and the digital interface 653 outputs the temperature sensed signal SR and the temperature compensation signal SENSE_COMP in a digital form. In order to output the temperature sensed signal SR and the temperature compensation signal SENSE_COMP in the digital form, the digital interface 653 may include an analog-to-digital converter (not shown) therein and employ the IIC-bus interface. A combination of the temperature sensed signal SR and the temperature compensation signal SENSE_COMP having the analog form outputted from the analog interface 651, and a combination of the temperature sensed signal SR and the temperature compensation signal SENSE_COMP having the digital form outputted from the digital interface 653, are used to adjust the gamma value to maintain a consistent display quality in spite of the temperature variation in the liquid crystal display panel 10.

The PWM modulator 655 modulates the temperature sensed signal SR and the temperature compensation signal SENSE_COMP to output a PWM signal SENSE_PWM. The PWM signal SENSE_PWM outputted from the PWM modulator 655 is applied to the backlight driver 170, thereby adjusting the brightness according to the temperature variation of the liquid crystal display panel 10.

As described above, the invention may effectively compensate for any variations in the gamma and brightness values caused by change in the temperature of the liquid crystal display panel. With the invention, the image display quality will not be adversely affected by a change in the inner temperature of the liquid crystal display panel.

Although exemplary embodiments of the present invention have been described, it is understood that the present invention should not be limited to these exemplary embodiments and various changes and modifications can be made by one of ordinary skill in the art within the spirit and scope of the present invention as hereinafter claimed.

1. A liquid crystal display comprising:
a liquid crystal panel having a plurality of pixels;
a temperature sensor provided inside the liquid crystal panel, the temperature sensor capable of sensing a temperature variation in the liquid crystal panel and outputting a sensing signal;
a sensor controller generating a temperature compensation signal in response to the sensing signal;
a timing controller outputting a color signal and determining a gamma value in response to the temperature compensation signal;
a gamma voltage generator generating a gamma voltage corresponding to the determined gamma value; and
a driver generating a data voltage corresponding to the color signal based on the gamma voltage;
wherein at least a portion of the temperature sensor has a general square wave shape.

2. The liquid crystal display of claim 1, wherein each of the pixels has a thin film transistor and the temperature sensor is formed on a same layer as a gate electrode of the thin film transistor.

3. The liquid crystal display of claim 1, wherein the temperature sensor is a metal resistor including at least one of molybdenum and aluminum.

4. The liquid crystal display of claim 1, wherein the temperature sensor is disposed under a light-blocking layer of the liquid crystal panel.

5. The liquid crystal display of claim 1, wherein the temperature compensation signal has an opposite polarity to a polarity of the sensing signal.

6. The liquid crystal display of claim 1, wherein the gamma voltage generator comprises a gamma buffer receiving the determined gamma value from the timing controller through a digital interface and storing the received gamma.

7. (canceled)

8. The liquid crystal display of claim 1, further comprising a backlight driver that compensates for a shift in brightness caused by the temperature variation in response to the temperature compensation signal.

9. The liquid crystal display of claim 8, wherein the backlight driver adjusts a tube current applied to a backlight assembly for the liquid crystal panel in accordance with a pulse width of the temperature compensation signal.

10. A liquid crystal display comprising:
a liquid crystal panel having a plurality of pixels;
a temperature sensor provided inside the liquid crystal panel, the temperature sensor capable of sensing a temperature variation of the liquid crystal panel and outputting a sensing signal;
a sensor controller that generates a temperature compensation signal having an opposite polarity to a polarity of the sensing signal in response to the sensing signal;
a gamma voltage generator having a gamma-compensator that adjusts a gamma value according to the temperature variation in response to the temperature compensation signal, the gamma voltage generator generating a gamma voltage corresponding to the adjusted gamma value; and
a driving circuit generating a data voltage based on the gamma voltage;
wherein at least a portion of the temperature sensor has a general square wave shape.

11. The liquid crystal display of claim 10, wherein each of the pixels has a thin film transistor and the temperature sensor is formed on a same layer as a gate electrode of the thin film transistor.

12. The liquid crystal display of claim 10, wherein the temperature sensor is a metal resistor including at least one of molybdenum and aluminum.

13. The liquid crystal display of claim 10, wherein the temperature sensor is disposed under a light-blocking layer of the liquid crystal panel.

14. The liquid crystal display of claim 10, wherein the gamma-compensator receives the temperature compensation signal from the sensing controller through an analog interface.

15. The liquid crystal display of claim 10, further comprising a backlight driver that compensates for change in brightness caused by the temperature variation in response to the temperature compensation signal.

16. The liquid crystal display of claim 15, wherein the backlight driver adjusts a tube current applied to a backlight assembly for the liquid crystal panel in accordance with a pulse width of the temperature compensation signal.
